(19) United States
(12) Patent Application Publication
(10) Pub. No.: US 2014/0342061 A1
(43) Pub. Date: Nov. 20, 2014

(54) FRUIT OR VEGETABLE PULP PROCESSING APPARATUS WITH DEFECT SEPARATOR AND ASSOCIATED METHODS

(71) Applicant: John Bean Technologies Corporation, Chicago, IL (US)

(72) Inventors: David GREEN, Lakeland, FL (US); Jose D. MILLA, Lakeland, FL (US); Michael L. SUTER, Lakeland, FL (US); Gregory W. SCHRADER, Lakeland, FL (US)

(73) Assignee: JOHN BEAN TECHNOLOGIES CORPORATION, Chicago, IL (US)

(21) Appl. No.: 13/894,884

(22) Filed: May 15, 2013

(51) Int. Cl. G01N 21/88

(52) U.S. Cl. CPC G01N 21/88
USPC 426/231; 99/486

(57) ABSTRACT

A fruit or vegetable pulp processor includes a defect separator configured to separate defects from a fruit or vegetable pulp stream. The defect separator may have associated therewith at least one adjustable control parameter relating to an amount of defect separation from the fruit or vegetable pulp stream. At least one image sensor may be configured to sense defects in the fruit or vegetable pulp stream, and a controller may be configured to adjust the at least one adjustable control parameter of the defect separator based upon sensed defects. Accordingly, the amount or level of defects in the fruit or vegetable pulp stream may be controlled to provide a desired balance between yield and quality.

### FIELD OF THE INVENTION

This invention relates to fruit or vegetable processing, and more particularly, to a system and method for controlling defects in fruit or vegetable pulp.

### BACKGROUND OF THE INVENTION

Citrus pulp is a type of fruit or vegetable pulp. Citrus pulp is separated from juice typically by processing the citrus pulp in a juice extractor, which strains out most of the seeds and membranes through a strainer tube to produce a citrus pulp and juice product. This juice product advances and is further processed at a juice finisher for separating citrus pulp from the juice. At this point in the processing, the pulp is somewhat “clean,” after having been separated from the seeds and membranes by processing through the strainer tube at the juice extractor.

It may be desirable in some cases to produce a larger pulp sack in a premium pulp system by recovering pulp sacks that are more intact. For example, this citrus pulp can be added back to the juice to form a final product, e.g., a pulpy orange juice, or the citrus pulp can be collected separately, cleaned and pasteurized, and shipped to customers that package their own juice or sell citrus pulp wholesale.

There are also an increasing number of customers that collect citrus pulp as a byproduct to sell for additional revenue. Thus, an increasing number of customers require citrus pulp to be processed with large and intact pulp sacks. One way to accomplish this goal is to design a juice extractor having larger openings in the strainer tube. Although larger, intact pulp sacks would be processed, the use of larger openings in a strainer tube has drawbacks, however, because undesired material and citrus pulp defects could pass through the openings.

One prior art approach is a premium pulp system using a juice extractor, and with cleaning in a fluidized bed cyclone in which pulp and juice are processed together to separate components out by gravity. The design of the fluidized bed cyclone allows fluid to enter in tangentially and spin, with 20-30% of pulpy juice ejected from the bottom and 70% ejected from the top as a pulp and juice product. In a preferred mode of operation, small seeds and peel particles are ejected from the bottom portion of the fluidized bed cyclone.

There are some drawbacks to this system because the defects that are remaining as part of the juice and citrus pulp may be unacceptable to some customers. These defects may include discolored pulp, peel or portions of peel, albedo or portions of albedo, seeds, portions of seeds, black specks, mold, and non-citrus material such as insects, insect larvae or insect parts. Different customers have different specifications concerning these defects, depending on the citrus pulp defect, category of juice, and customer end use. In some cases, defects are unacceptable at any level. While most cyclone systems are able to be manually adjusted to allow for more or less defect separation, there does not exist any quick feedback mechanism to allow for such adjustment. Pulp processors therefore typically rely on manual inspection and manual counting of defects in the final finished pulp product in order to determine if it is desirable to adjust the cyclone parameters. Because of the time delay to manually count pulp defects, such cyclone systems are not typically adjusted on a regular basis, but may only be adjusted on a weekly or monthly basis.

Another prior art approach is to detect and remove defects from the pulp at or near the point of detection. For example, U.S. Pat. No. 6,727,452 assigned to the assignee of the present invention and incorporated herein in its entirety by reference, discloses a system and method that removes defects from citrus pulp. An advancing mechanism advances citrus pulp along a predetermined path of travel into an inspection zone. A citrus pulp imager is positioned at the inspection zone and acquires image data of the citrus pulp. A processor is connected to the citrus pulp imager and receives the image data and processes the image data to determine defects within the citrus pulp. A rejection mechanism rejects the flow of citrus pulp determined to be defective. While the '452 patent represents a significant advance in the processing of pulp, the complete rejection of pulp including defects reduces processing yield.

### SUMMARY OF THE INVENTION

In view of the foregoing background, it is therefore an object of the present invention to provide a fruit or vegetable pulp processing apparatus and associated method for controlling defects in a fruit or vegetable pulp stream and while providing higher yield.

This and other objects, features and advantages in accordance with the invention are provided by a fruit or vegetable pulp processing apparatus comprising a defect separator configured to separate defects from a fruit or vegetable pulp stream. The defect separator may have associated therewith at least one adjustable control parameter relating to an amount of defect separation from the fruit or vegetable pulp stream. The apparatus may further include at least one image sensor configured to sense defects in the fruit or vegetable pulp stream, and a controller configured to adjust the at least one adjustable control parameter of the defect separator based upon sensed defects in the fruit or vegetable pulp stream. Accordingly, the amount or level of defects in the fruit or vegetable pulp stream may be controlled to provide a desired balance between yield and quality. The fruit or vegetable pulp may comprise citrus pulp, for example.

The apparatus may further include a diverter configured to selectively divert the fruit or vegetable pulp stream. Accordingly, the controller may be configured to operate the diverter to divert the fruit or vegetable pulp stream when the sensed defects are above an adjustment threshold. In addition, the controller may be configured to adjust the at least one adjustable control parameter so that sensed defects are below an operating threshold. In other words when the defects are above a level where adjustment of the separator would succeed, the fruit or vegetable pulp stream may be diverted to be discarded or be set aside for other uses. When defects are above an operating threshold the separator may be adjusted to reduce the defects.

The defect separator may comprise at least one cyclone separator. For example, the at least one cyclone separator may comprise a cyclone body, and a controllable outlet valve coupled to a lower end of the cyclone body so that the at least one adjustable control parameter comprises a setting of the controllable outlet valve. The at least one cyclone separator may also comprise a plurality thereof, and a valve arrangement may be coupled to the cyclone separators so that the at least one adjustable control parameter comprises a selectable number of the plurality of cyclone separators coupled in series. In addition, the at least one adjustable control parameter may comprise an input flow rate to the at least one cyclone separator.

The at least one image sensor may comprise a downstream image sensor positioned downstream from the defect separator. In these embodiments, the controller may operate in a feedback control mode. In other embodiments, the at least one image sensor may comprise an upstream image sensor positioned upstream from the defect separator, and the controller may thus operate in a feedforward control mode. Of course, in some embodiments, both image sensors may be provided. A fruit or vegetable juice and pulp extractor may be provided to supply the fruit or vegetable pulp stream.

A method aspect is directed to fruit or vegetable pulp processing. The method may include operating a defect separator to separate defects from a fruit or vegetable pulp stream, with the defect separator having associated therewith at least one adjustable control parameter relating to an amount of defect separation from the fruit or vegetable pulp stream. The method may also include sensing defects in the fruit or vegetable pulp stream using at least one image sensor, and operating a controller to adjust the at least one adjustable control parameter of the defect separator based upon sensed defects in the fruit or vegetable pulp stream.

### BRIEF DESCRIPTION OF THE DRAWINGS

FIG. 1 is a schematic block diagram of a citrus pulp processing apparatus according to the invention.

FIG. 2 is a schematic block diagram of another embodiment of a citrus pulp processing apparatus according to the invention.

FIG. 3 is a schematic block diagram of yet another citrus pulp processing apparatus according to the invention.

FIG. 4 is a schematic block diagram, partially in section, of a defect sampling cell including an image sensor as may be used in the apparatus shown in FIGS. 1 and 2.

FIG. 5 is a schematic block diagram of a defect separator including cyclones as may be used in the apparatus shown in FIGS. 1 and 2.

FIG. 6 is a flowchart for a method in accordance with the present invention.

### DETAILED DESCRIPTION OF THE EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

In the following description, an example of citrus pulp processing is used to fully explain the structures and concepts disclosed herein to those skilled in the art. In addition, those of skill in the art will recognize that these same structures and concepts are also applicable to other types of fruit or vegetable pulp.

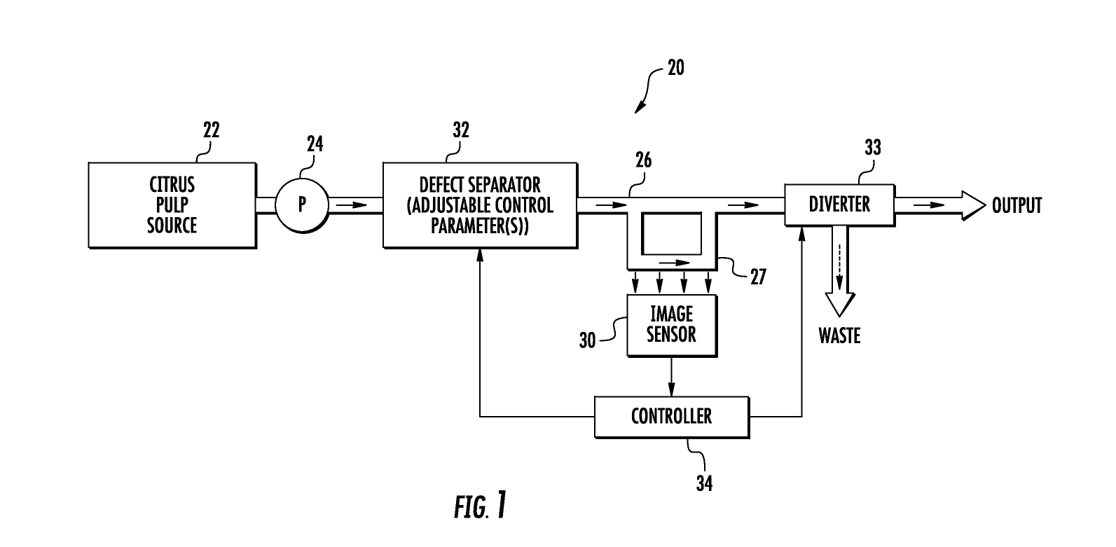

Referring initially to FIG. 1 an embodiment of a citrus pulp processing apparatus 20 is now described. The apparatus 20 includes a citrus pulp source 22 which may be provided by a storage tank containing a mixture of citrus pulp and citrus juice, or may be provided from the output of a citrus juice extractor of the type available from JBT FoodTech Citrus Systems in Lakeland, Fla. A pump 24 is illustratively coupled to the output of the citrus pulp source 22, although in some embodiments the pump may not be used. In other embodiments, the citrus pulp and juice may be provided from the output of a citrus finisher of the type also available from JBT FoodTech Citrus Systems in Lakeland, Fla.

The apparatus 20 also includes a defect separator 32 downstream from the pump 24. The defect separator 32 may have one more adjustable control parameters that permit control of a processing parameter that reduces defects if present in the pulp stream. Of course, a typical separator will trade off the amount of pulp that is passed therethrough with the number of defects that are also passed. In other words, yield may be temporarily sacrificed to reduce defects when present thereby increasing quality or ensuring quality remains above a specified level. When defects are not present, or are only present below a threshold, the defect separator 32 may be adjusted to increase yield.

Downstream from defect separator 32 a main path 26 directs the pulp stream to a diverter 33. The diverter 33 may dump the entire citrus pulp stream to waste, for example, when the level of defects exceeds an adjustment threshold established by the processing plant. During the times when the level of defects are less than the adjustment threshold, the diverter 33 passes the citrus stream to the output for further processing and/or packaging as will be understood by those skilled in the art.

A sample path 27 of the pulp stream is coupled in parallel to the main path 26 and directs a sample portion of the citrus pulp stream past an image sensor 30. This sample portion may be a small fraction of the citrus pulp stream, and, in some embodiments, the sample portion may be discarded rather than returned to the main path 26. In yet other embodiments, the main path 26 of the pulp stream may be directed to the image sensor 30, that is, in these embodiments, no sample path is used.

The image sensor 30, in turn, is illustratively coupled to a controller 34. The controller 30 also has outputs used to adjust the adjustable control parameter of the defect separator 32, as well as operate the diverter 33. In other words, when the defects are above a level where adjustment of the separator 32 would succeed, the citrus pulp stream may be diverted to be discarded or for other uses. In some embodiments, the diverter may not be used.

In the illustrated embodiment, the apparatus 20 implements a feedback type of control wherein the controller 34 is configured to adjust the at least one adjustable control parameter of the defect separator 32 based upon defects sensed by the image sensor 30. The controller 34 may be configured to adjust the at least one adjustable control parameter of the defect separator 32 so that sensed defects at the image sensor 30 are below an operating threshold. Accordingly, the amount or level of defects in the citrus pulp stream may be controlled to provide a desired balance between yield and quality.

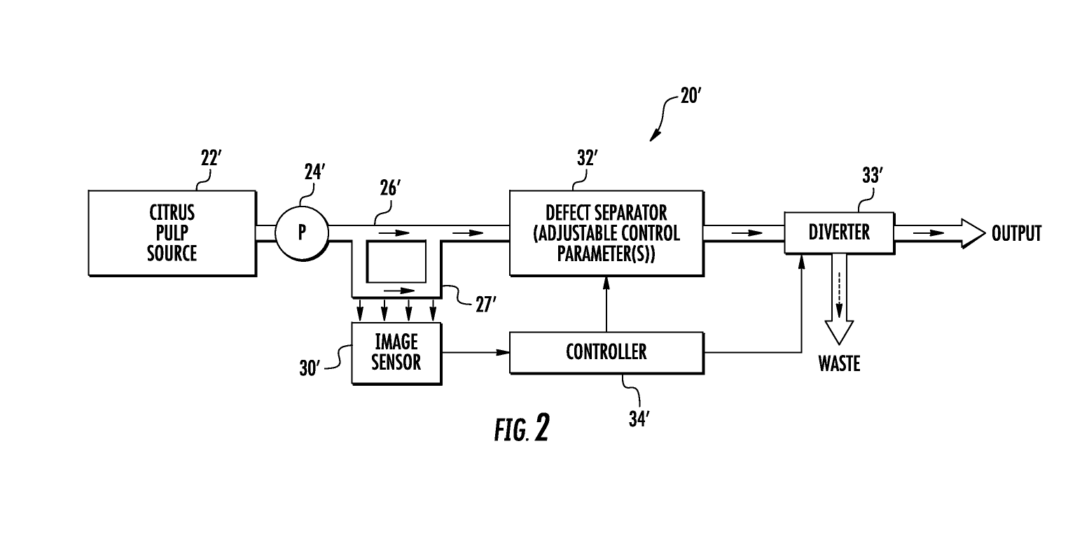

A feedforward control scheme apparatus 20′ is explained with reference to FIG. 2. In this embodiment, the apparatus 20′ includes the main path 26′ coupling the citrus pulp stream first from the citrus pulp source 22′, then through the pump 24′ and to the downstream defect separator 32′. The sample path 27 is routed in parallel with the main path 26′. The image sensor 30′ is thus used to sense the defect level prior to the defect separator 32′. The controller 34′ operates using a feedforward mapping of the defect level to the at least one adjustable control parameter of the defect separator 32′. The diverter 33′ may operate similar to the diverter 33 described above with respect to the apparatus 20 shown in FIG. 1.

The image sensor may comprise a downstream image sensor 30 (FIG. 1) positioned downstream from the defect separator 32. In these embodiments, the controller 34 (FIG. 1) may operate in a feedback control mode. In other embodiments, the image sensor may comprise an upstream image sensor 30′ (FIG. 2) positioned upstream from the defect separator 32′, and the controller 34′ may thus operate in a feedforward control mode. Of course, in some embodiments, both image sensors may be provided.

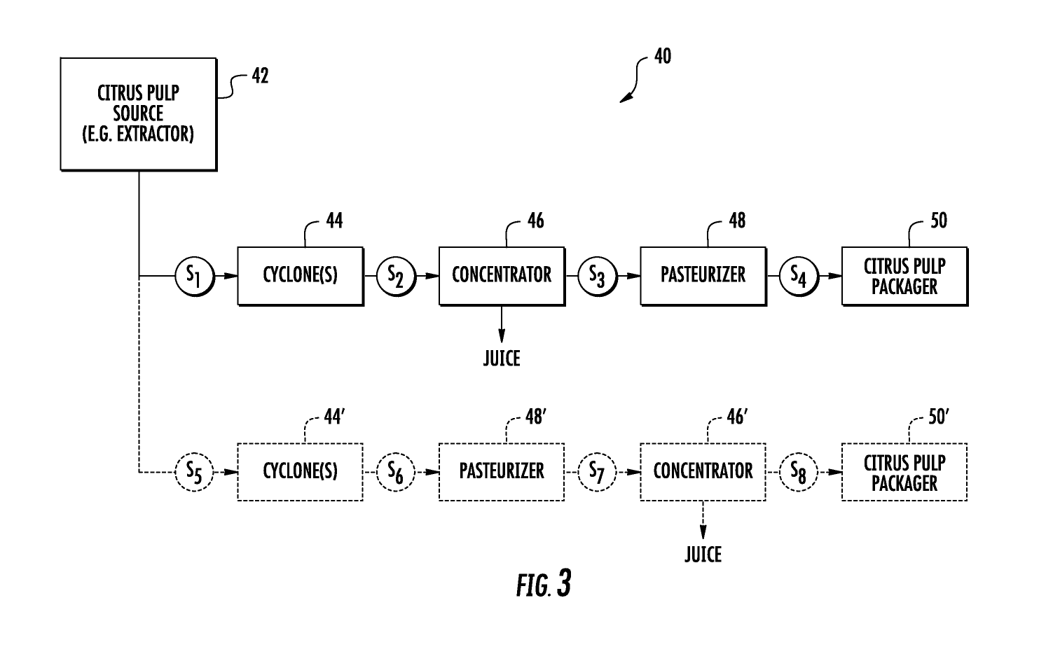

Referring now briefly to the apparatus 40 shown in FIG. 3, further processing details are now described along with additional sampling points S1-S8. More particularly, along the upper citrus pulp stream path, a defect separator in the form of a cyclone or cyclones 44, juice concentrator 46, pasteurizer 48 and citrus pulp packager 50 are coupled in series to the citrus pulp source (e.g. extractor) 42. Four usable sampling points S1-S4 are provided between adjacent devices. Any or all of the sampling points S1-S4 may be used along with the image sensor 30 (FIG. 1) to sense a level of defects, which, in turn, may be used to control an adjustable parameter of the cyclone or cyclone separators 44. The alternative bottom citrus pulp stream path, exchanges the positions of the concentrator 46′ and pasteurizer 48′, between the cyclones 44′ and citrus pulp packager 50′. In this arrangement, four sampling points are also provided S5-S8, and these points may also be used as described above.

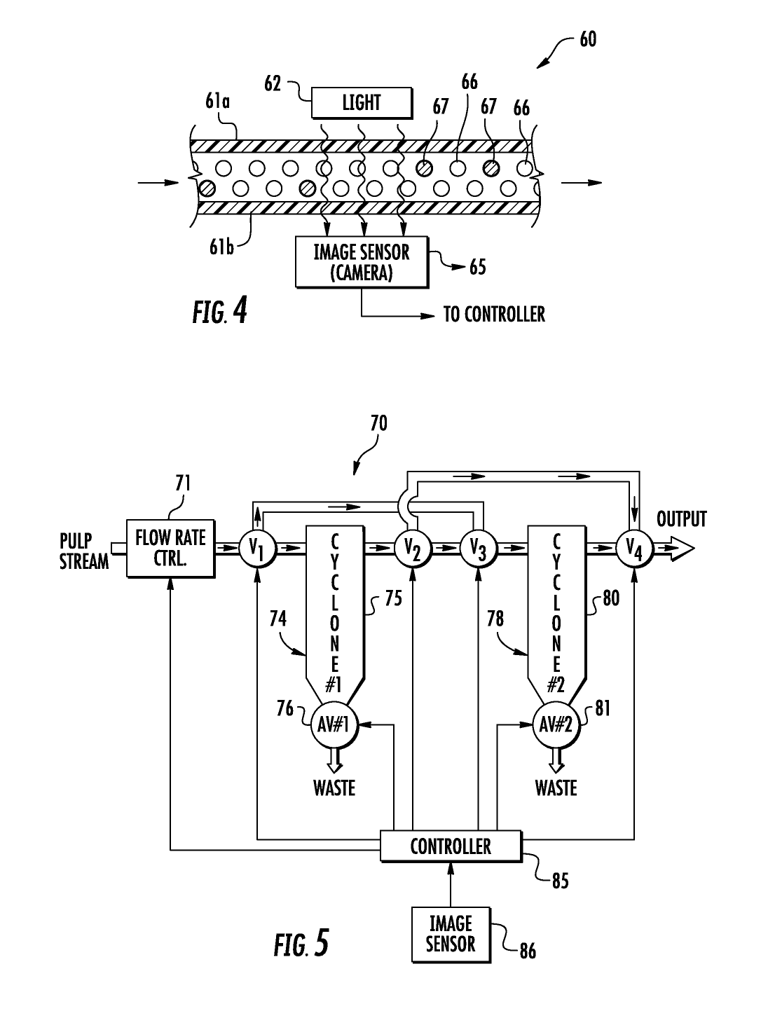

Referring now to the schematic diagram of FIG. 4, an example of a defect sampling cell 60 is now described. The cell 60 includes a pair of spaced apart transparent plates 61a-61b which contains a mixture of citrus pulp pieces 66, juice, and defects 67. The mixture may be continuously advanced, or may be run between the plates 61a, 61b in a batch operation as will be appreciated by those skilled in the art. A light 62 is positioned adjacent the top plate 61a and the image sensor or camera 65 is positioned adjacent the lower plate 61b. The image sensor 65 may capture an image of a sample of the pulp stream, which, in turn, may be collected and processed by the controller to determine a number of defects per volume of the mixture, for example. There are many other arrangements of image sensors 65 contemplated, such as, for example, an arrangement including a line scanning camera may be used. In addition, illumination may come from the same side as the image sensor 65, or ambient illumination only may be used. Other defect sampling and image sensing arrangements may also be used, such as disclosed in U.S. Pat. No. 6,727,452.

Referring now additionally to FIG. 5, an exemplary defect separator 70 will now be described. In the illustrated embodiment, the separator includes a first cyclone 74 and a second cyclone 78. The first cyclone includes a first cyclone body 75 and a controllable apex valve or first outlet valve 76 coupled to a lower end of the cyclone body so that the at least one adjustable control parameter comprises a setting of the controllable outlet valve.

For example, the first outlet valve 76 may be an electromagnetically controllable valve having a plurality of discrete positions, e.g. three, so that the defect separation versus yield may be controlled by the controller 85 and based upon defects sensed by the image sensor 86. In other embodiments, the first outlet valve 76 may include a pneumatic actuator with position feedback control, for example. Similarly, the second cyclone 78 illustratively includes a second cyclone body 80 and a second controllable outlet valve 81 coupled thereto at the lower end thereof. Adjusting the outlet valve to increase throughput of a cyclone increases yield, but also permits a higher level of defects to pass. Conversely, adjusting the outlet valve to decrease throughput of a cyclone decreases yield, but also reduces the defect level.

In the illustrated embodiment, the defect separator 70 includes first and second cyclone separators 74, 78 which may be coupled in a series to provide increased defect removal, or which be coupled in parallel to provide increased volume throughput, based upon the configuration of the valve arrangement provided by control valves V1-V4. The control valves V1-V4 may be electromagnetically controlled via the controller 85 to connect both of the cyclones 74, 78 in series or in parallel as will be appreciated by those skilled in the art. Accordingly, one of the adjustable control parameters is a number of cyclones coupled in series. For example, for two cyclones, each passing 70% of the flow and removing 90% of the defects, a pair of cyclones connected in series produces 49% of the volume and reduces the defects by 98%. The illustrated example using two cyclones can be extended to additional cyclones that can be connected in parallel for greater throughput or in series for greater defect removal at the expense of yield.

Yet another adjustable control parameter for the defect separator 70 relates to the flow rate through the cyclones 74, 78, as controlled by the illustrated flow rate controller 71. The flow rate controller 71 may be in the form of a flow rate control valve or may in the form of a controllable pump, for example. The flow rate of the citrus pulp stream through the cyclones 74, 78 is another adjustable control parameter that permits a tradeoff between defect separation and yield.

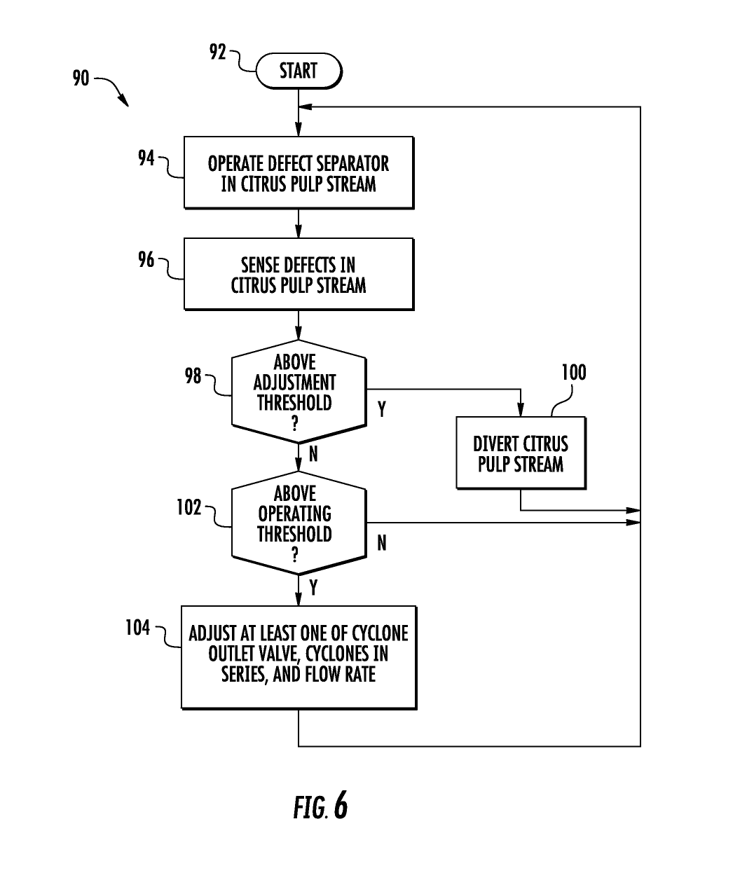

Referring now additionally to the flowchart 90 of FIG. 6, method aspects are now more fully described. From the start (Block 92), the method includes operating the defect separator in the citrus pulp stream to remove defects at Block 94. The defect separator, as described above, has associated therewith at least one adjustable control parameter relating to an amount of defect separation from the citrus pulp stream. At Block 96 the method includes sensing and, for example, counting defects in the citrus pulp stream using at least one image sensor. In some embodiments, the defects are sensed in a sample stream, either continuously or in a batch process.

If the defect level is above an adjustment threshold as determined at Block 98, the citrus pulp stream is diverted from the output at Block 100. In other words, if the defect level is sufficiently high, the defect separator may not be able to reduce the defects sufficiently, and the citrus pulp stream is fully diverted so as to not affect the citrus output. Of course, this diversion step is optional and may not be used in some embodiments.

If the defect level is below an adjustment threshold as determined at Block 98, then at Block 102 it is determined whether the defect level is above the desired or operating threshold. If the defect level is not above the operating threshold, then the process continues at Block 94. If, however, the defect level is above the operating threshold (Block 102) at least one of the cyclone outlet valves is adjusted, or a number of cyclones in series is adjusted, or the flow rate is adjusted, or any combination of these adjustments of the defect separator is performed so that the defect level is reduced to below the operating threshold. These adjustments, if needed, can be made in real time by the controller.

The type and amount of adjustment of the defect separator may be configured so that a desired high yield is provided while still ensuring an adequate quality. Accordingly, if the defect level is less than the operating threshold, an adjustment may be made to increase the yield as long as the defect level will remain below the operating threshold.

The method just described is for a feedback type control arrangement and those of skill in the art will readily recognize that the feedforward method is similar and requires no further discussion herein. Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A fruit or vegetable pulp processing apparatus comprising:
a defect separator configured to separate defects from a fruit or vegetable pulp stream, and having associated therewith at least one adjustable control parameter relating to an amount of defect separation from the fruit or vegetable pulp stream;
at least one image sensor configured to sense defects in the fruit or vegetable pulp stream; and
a controller configured to adjust the at least one adjustable control parameter of said defect separator based upon sensed defects in the fruit or vegetable pulp stream.

2. The fruit or vegetable pulp processing apparatus according to claim 1 wherein the fruit or vegetable pulp comprises citrus pulp.

3. The fruit or vegetable pulp processing apparatus according to claim 1 further comprising a diverter configured to divert the fruit or vegetable pulp stream; and wherein said controller is configured to operate said diverter to selectively divert the fruit or vegetable pulp stream when the sensed defects are above an adjustment threshold.

4. The fruit or vegetable pulp processing apparatus according to claim 1 wherein said controller is configured to adjust the at least one adjustable control parameter so that sensed defects are below an operating threshold.

5. The fruit or vegetable pulp processing apparatus according to claim 1 wherein said defect separator comprises at least one cyclone separator.

6. The fruit or vegetable pulp processing apparatus according to claim 5 wherein said at least one cyclone separator comprises a cyclone body and a controllable outlet valve coupled to a lower end thereof so that the at least one adjustable control parameter comprises a setting of said controllable outlet valve.

7. The fruit or vegetable pulp processing apparatus according to claim 5 wherein said at least one cyclone separator comprises a plurality thereof; and further comprising a valve arrangement coupled to said plurality of cyclone separators so that the at least one adjustable control parameter comprises a selectable number of said plurality of cyclone separators coupled in series.

8. The fruit or vegetable pulp processing apparatus according to claim 5 wherein the at least one adjustable control parameter comprises an input flow rate to said at least one cyclone separator.

9. The fruit or vegetable pulp processing apparatus according to claim 1 wherein said at least one image sensor comprises a downstream image sensor positioned downstream from said defect separator; and wherein said controller operates in a feedback control mode.

10. The fruit or vegetable pulp processing apparatus according to claim 1 wherein said at least one image sensor comprises an upstream image sensor positioned upstream from said defect separator; and wherein said controller operates in a feedforward control mode.

11. The fruit or vegetable pulp processing apparatus according to claim 1 further comprising a fruit or vegetable juice and pulp extractor configured to supply the fruit or vegetable pulp stream.

12. A fruit or vegetable pulp processing apparatus comprising:
at least one cyclone configured to separate defects from a fruit or vegetable pulp stream and having associated therewith at least one adjustable control parameter relating to an amount of defect separation from the fruit or vegetable pulp stream;
a diverter configured to divert the fruit or vegetable pulp stream;
at least one image sensor configured to sense defects in the fruit or vegetable pulp stream; and
a controller configured to adjust the at least one adjustable control parameter of said at least one cyclone and operate said diverter to selectively divert the fruit or vegetable pulp stream based upon the sensed defects in the fruit or vegetable pulp stream.

13. The fruit or vegetable pulp processing apparatus according to claim 12 wherein the fruit or vegetable pulp comprises citrus pulp.

14. The fruit or vegetable pulp processing apparatus according to claim 12 wherein said controller is configured to operate said diverter to selectively divert the fruit or vegetable pulp stream when the sensed defects are above an adjustment threshold.

15. The fruit or vegetable pulp processing apparatus according to claim 12 wherein said controller is configured to adjust the at least one adjustable control parameter so that sensed defects are below an operating threshold.

16. The fruit or vegetable pulp processing apparatus according to claim 12 wherein said at least one cyclone separator comprises a cyclone body and a controllable outlet valve coupled to a lower end thereof so that the at least one adjustable control parameter comprises a setting of said controllable outlet valve.

17. The fruit or vegetable pulp processing apparatus according to claim 12 wherein said at least one cyclone separator comprises a plurality thereof; and further comprising a valve arrangement coupled to said plurality of cyclone separators so that the at least one adjustable control parameter comprises a selectable number of said plurality of cyclone separators coupled in series.

18. The fruit or vegetable pulp processing apparatus according to claim 12 wherein the at least one adjustable control parameter comprises an input flow rate to said at least one cyclone separator.

19. The fruit or vegetable pulp processing apparatus according to claim 12 wherein said at least one image sensor comprises a downstream image sensor positioned downstream from said defect separator; and wherein said controller operates in a feedback control mode.

20. The fruit or vegetable pulp processing apparatus according to claim 12 wherein said at least one image sensor comprises an upstream image sensor positioned upstream from said defect separator; and wherein said controller operates in a feedforward control mode.

21. A method of fruit or vegetable pulp processing comprising:
operating a defect separator to separate defects from a fruit or vegetable pulp stream, the defect separator having associated therewith at least one adjustable control parameter relating to an amount of defect separation from the fruit or vegetable pulp stream;
sensing defects in the fruit or vegetable pulp stream using at least one image sensor; and
operating a controller to adjust the at least one adjustable control parameter of the defect separator based upon sensed defects in the fruit or vegetable pulp stream.

22. The method according to claim 21 wherein the fruit or vegetable pulp comprises citrus pulp.

23. The method according to claim 21 further comprising operating the controller to selectively divert the fruit or vegetable pulp stream when the sensed defects are above an adjustment threshold.

24. The method according to claim 21 wherein operating controller comprises operating the controller to adjust the at least one adjustable control parameter so that sensed defects are below an operating threshold.

25. The method according to claim 21 wherein the defect separator comprises at least one cyclone separator.

26. The method according to claim 25 wherein the at least one cyclone separator comprises a cyclone body and a controllable outlet valve coupled to a lower end of the cyclone body so that the at least one adjustable control parameter comprises a setting of the controllable outlet valve.

27. The method according to claim 25 wherein the at least one cyclone separator comprises a plurality thereof; and further comprising operating a valve arrangement coupled to the plurality of cyclone separators so that the at least one adjustable control parameter comprises a selectable number of the plurality of cyclone separators coupled in series.

28. The method according to claim 25 wherein the at least one adjustable control parameter comprises an input flow rate to the at least one cyclone separator.

29. The method according to claim 21 wherein the at least one image sensor comprises a downstream image sensor positioned downstream from the defect separator; and wherein operating the controller comprises operating the controller in a feedback control mode.

30. The method according to claim 21 wherein the at least one image sensor comprises an upstream image sensor positioned upstream from the defect separator; and wherein operating the controller comprises operating the controller in a feedforward control mode.
